(19) United States
(12) Patent Application Publication
(10) Pub. No.: US 2025/0376892 A1
(43) Pub. Date: Dec. 11, 2025

(54) FENESTRATION UNIT FRAMES AND FENESTRATION UNITS WITH CONCEALED INTUMESCENT MEMBERS

(71) Applicant: ANDERSEN CORPORATION, Bayport, MN (US)

(72) Inventors: Arik Van Asten, Minneapolis, MN (US); Craig Johnson, North Oaks, MN (US); Paul Smith, Stillwater, MN (US)

(21) Appl. No.: 19/225,018

(22) Filed: Jun. 2, 2025

Related U.S. Application Data
(60) Provisional application No. 63/656,364, filed on Jun. 5, 2024.

(51) Int. Cl. E06B 5/16

(52) U.S. Cl. CPC E06B 5/164

(57) ABSTRACT

Fenestration unit frames and fenestration units with concealed intumescent members are described herein along with related methods. The fenestration unit frames and fenestration units incorporating the fenestration unit frames described herein include one or more concealed intumescent members configured to expand to occupy gaps that may be found between one or more edges of a fire-rated panel and the fenestration unit frame in which the panel is located during a fire event.

### RELATED APPLICATION

This application claims the benefit under 35 U.S.C. § 119 of U.S. Provisional Application Ser. No. 63/656,364 filed 5 Jun. 2024 and titled FENESTRATION UNIT FRAMES AND FENESTRATION UNITS WITH CONCEALED INTUMESCENT MEMBERS, which is incorporated herein by reference in its entirety.

Fenestration unit frames and fenestration units with concealed intumescent members are described herein along with related methods.

Fire doors are required and/or used in buildings to resist the passage of fire through the openings in which the fire doors are located. Fire doors are typically rated based on a combination of temperature and time exposure with the rating increasing as the doors are capable of resisting failure at higher temperatures and/or longer exposure times.

### SUMMARY

Fenestration unit frames and fenestration units with concealed intumescent members are described herein along with related methods.

The fenestration unit frames and fenestration units incorporating the fenestration unit frames described herein include one or more concealed intumescent members configured to expand to occupy gaps that may be found between one or more edges of a fire-rated panel and the fenestration unit frame in which the panel is located during a fire event.

Intumescent materials typically expand when exposed to sufficient heat and/or flame and are commonly used to enhance the fire resistance of items and/or structures. Although strips of intumescent materials are used in building structures they are typically applied directly to the exterior of the panel or the frame. As a result, the intumescent members are typically visible to users and, perhaps more importantly, exposed to environmental conditions such as water (e.g., rain), water vapor (e.g., humidity), sunlight, etc. that could potentially, over time, degrade the intumescent materials in the members in a way that could impact their ability to expand when exposed to heat and/or flame when needed. Further, placement of strips of intumescent material on exterior surfaces can require careful alignment of the strip in or on a selected location.

Fenestration unit frames and fenestration units incorporating the fenestration unit frames described herein include one or more concealed intumescent members positioned in cavities formed in one or more frame members (e.g., jambs, sills, rails, stiles, etc.). Although fenestration unit frames having cavities formed therein are known, fire resistant doors and other fire resistant fenestration units including frame members with cavities are typically constructed of steel or other inherently fire resistant materials. Because those materials do not typically degrade during a fire event for which the fire-resistant fenestration unit is rated, including intumescent material within the cavities of those fire resistant frames prevents the intumescent material from filling gaps between the edges of a panel (e.g., a door panel) and the frame member containing the cavity in which the intumescent material is located.

In contrast, the fenestration unit frames and fenestration units incorporating the fenestration unit frames described herein include one or more cavities in which at least a portion of the cavity is constructed of thermally sacrificial material configured to degrade when subjected to heat and/or flame. As a result, although located within a cavity in the fenestration unit frame, the intumescent member located therein is exposed to heat and/or flame when the thermally sacrificial material of the cavity melts and/or disintegrates. The exposed intumescent member is then able to expand to fill a gap between the fenestration unit frame and the panel located therein.

In one or more embodiments, a determination as to whether material falls within the definition of “thermally sacrificial material” and “sacrificial material” as defined in connection with this invention can be based on fire tests commonly used to certify fenestration units as fire resistant for, e.g., building code purposes, etc. For purposes of this invention, The Underwriters Laboratory UL 10C, Standard for Positive Pressure Fire Tests of Door Assemblies, Third Edition with revisions through May 27, 2021 fire test (referred to herein as “UL 10C Fire Test”) is used to determine whether a material is a sacrificial material. As used herein, “thermally sacrificial material” or “sacrificial material” is material that degrades and loses its structural integrity through one or more of melting, disintegration, charring, and foaming, etc. such that an intumescent member in a cavity of a fenestration unit frame member constructed of the sacrificial material can expand to occupy the volume occupied by the sacrificial material when the fenestration unit is subjected to the UL 10C Fire Test as set forth in Appendix A of the UL 10C Fire Test for a period of 20 minutes to 60 minutes.

In one or more embodiments, it may be particularly beneficial to provide an intumescent member in the cavity of a head jamb of a fenestration unit in the form of a hinged panel rotating about a vertical axis extending through hinges attached to a side jamb. During a fire event, the door panel may essentially fall such that the bottom edge of the panel sits on a sill (and/or on the bottom of the rough opening in which the fenestration unit is located) as the side jamb to which the hinges are attached degrades during the fire event. That downward shift of the panel may be the result of degradation in the side jamb itself and/or the hinges supporting the panel within the fenestration unit frame. That movement of the panel within the fenestration unit frame increases any gap between the panel and the head jamb/rough opening which can be detrimental to controlling the progress of a fire through opening in which the fenestration unit is installed. An intumescent member located within a cavity in the head jamb of such a fenestration unit can, however, expand to fill even that enlarged gap between the head jamb/rough opening and the top edge of the panel and, thus, help control the progress of a fire.

Further, positioning intumescent members in cavities of fenestration unit frame members separately can provide benefits over known attempts to provide intumescent materials with jambs constructed of sacrificial materials that involve, for example, coextrusion of intumescent materials along with other structural and/or sacrificial materials. In particular, coextrusion of intumescent materials with other known building materials may prove difficult. Placement of one or more intumescent members in a cavity of a frame member of a fenestration unit frame as described herein, however, is a straightforward and simple process that, further, allows the manufacturer to provide intumescent material only where it is most beneficial and only when the fenestration unit incorporating such a frame member is to be certified for a fire resistant location of a building.

In a first aspect, one or more embodiments of a fenestration unit as described herein includes: a frame comprising a first side jamb and a second side jamb connected to each other by a head jamb and a sill, wherein each of the first side jamb, the second side jamb, and the head jamb comprise an inner side and an outer side, wherein the outer side of each of the first side jamb, the second side jamb, and the head jamb are configured to face a building opening in which the frame is positioned when installed; a panel retained in the frame, the panel comprising a pair of major surfaces and a set of edges extending between the major surfaces about a perimeter of the panel, the set of edges comprising a top edge facing the inner side of the head jamb; a head cavity located in the head jamb, wherein the head cavity is aligned with a head axis extending through the head jamb between the first side jamb and the second side jamb, and wherein the frame cavity is enclosed between the first side jamb and the second side jamb; and an intumescent member located in the head cavity, the intumescent member aligned with the head axis and comprising intumescent material; wherein at least a portion of the head cavity is defined by a sacrificial wall constructed of thermally sacrificial material such that the intumescent member expands outside of the head cavity into a head gap between the top edge of the panel and the outer side of the head jamb.

In one or more embodiments of a fenestration unit as described herein, the intumescent member comprises a strip of intumescent material extending between the first side jamb and the second side jamb.

In one or more embodiments of a fenestration unit as described herein, the intumescent member is sealed within the head cavity when the fenestration unit is installed in a building opening.

In one or more embodiments of a fenestration unit as described herein, the intumescent member is sealed within the head cavity before the fenestration unit is installed in a building opening.

In one or more embodiments of a fenestration unit as described herein, the head cavity is constructed of the thermally sacrificial material.

In one or more embodiments of a fenestration unit as described herein, the head jamb is constructed of the thermally sacrificial material.

In one or more embodiments of a fenestration unit as described herein, the intumescent member occupies only a portion of a volume of the head cavity.

In one or more embodiments of a fenestration unit as described herein, the intumescent member comprises a separate and discrete strip of intumescent material positioned in the head cavity.

In one or more embodiments of a fenestration unit as described herein, at least a portion of the head cavity is located between the outer side of the head jamb and the top edge of the panel.

In one or more embodiments of a fenestration unit as described herein, the head cavity comprises a first head cavity and the intumescent member comprises a first intumescent member, and wherein the head jamb comprises a second head cavity separate and distinct from the first head cavity, the second head cavity located between the inner side and the outer side of the head jamb and aligned with the head axis, the fenestration unit comprising a second intumescent member located in the second head cavity and aligned with the head axis. In one or more embodiments, the second head cavity is located between the outer side of the head jamb and the top edge of the panel.

In one or more embodiments of a fenestration unit as described herein, the first side jamb comprises an inner side facing a side edge of the panel when the panel is located within the frame; wherein a jamb cavity is located in the first side jamb, wherein the jamb cavity is aligned with a jamb axis extending through the first side jamb from a head end of the first side jamb proximate between the head jamb to a sill end proximate the sill, and wherein the jamb cavity is enclosed between the head jamb and the sill end; and a jamb intumescent member located in the jamb cavity, the jamb intumescent member aligned with the jamb axis and comprising intumescent material; wherein at least a portion of the jamb cavity is defined by a sacrificial wall constructed of thermally sacrificial material such that the jamb intumescent member expands outside of the jamb cavity into a jamb gap between the side edge of the panel and the outer side of the first side jamb. In one or more embodiments, the jamb intumescent member comprises a strip of intumescent material extending between the head end and the sill end of the first side jamb. In one or more embodiments, the jamb intumescent member is sealed within the jamb cavity when the fenestration unit is installed in a building opening. In one or more embodiments, the jamb cavity is constructed of the thermally sacrificial material. In one or more embodiments, the first side jamb is constructed of the thermally sacrificial material. In one or more embodiments, the jamb intumescent member occupies only a portion of a volume of the jamb cavity. In one or more embodiments, the jamb intumescent member comprises a separate and discrete strip of intumescent material positioned in the jamb cavity. In one or more embodiments, at least a portion of the jamb cavity is located between the outer side of the first side jamb and the side edge of the panel. In one or more embodiments, the jamb cavity comprises a first jamb cavity and the jamb intumescent member comprises a first jamb intumescent member, and wherein the first side jamb comprises a second jamb cavity separate and distinct from the first jamb cavity, the second jamb cavity located between the inner side and the outer side of the first side jamb and aligned with the jamb axis, the fenestration unit comprising a second jamb intumescent member located in the second jamb cavity and aligned with the jamb axis. In one or more embodiments, the second jamb cavity is located between the outer side of the first side jamb and the side edge of the panel.

In a second aspect, one or more embodiments of a method of assembling a fenestration unit frame with concealed fire protection as described herein includes: positioning an intumescent member in a cavity of a first jamb of the fenestration unit frame, wherein a first end of the intumescent member is proximate a first end of the first jamb and a second end of the intumescent member is proximate a second end of the first jamb, and wherein the cavity is enclosed within the first jamb from the first end of the first jamb to the second end of the first jamb; attaching a second jamb to the first end of the first jamb; and retaining the intumescent member in the cavity.

In one or more embodiments of a method of assembling fenestration unit frame with concealed fire protection as described herein, the intumescent member comprises a separate and discrete article from the first jamb, and wherein positioning the intumescent member in the cavity comprises inserting the intumescent member into the cavity.

In one or more embodiments of a method of assembling fenestration unit frame with concealed fire protection as described herein, positioning the intumescent member in the cavity comprises inserting the first end of the intumescent member into the cavity at the second end of the first jamb and advancing the first end of the intumescent member through the cavity towards the first end of the first jamb.

In one or more embodiments of a method of assembling fenestration unit frame with concealed fire protection as described herein, the method comprises providing the intumescent member comprising the first end and the second end before positioning the intumescent member in the cavity.

In one or more embodiments of a method of assembling fenestration unit frame with concealed fire protection as described herein, retaining the intumescent member in the cavity comprises obstructing a first opening of the cavity at the first end of the first jamb. In one or more embodiments, the method comprises attaching a second jamb of the fenestration unit frame to the first jamb, and wherein obstructing the first opening comprises attaching the second jamb to the first jamb proximate the first opening. In one or more embodiments, the method comprises attaching a second jamb of the fenestration unit frame to the first jamb, and wherein obstructing the first opening comprises obstructing the first opening before attaching the second jamb to the first jamb.

In one or more embodiments of a method of assembling fenestration unit frame with concealed fire protection as described herein, retaining the intumescent member in the cavity comprises inserting a mechanical fastener into the cavity.

In one or more embodiments of a method of assembling fenestration unit frame with concealed fire protection as described herein, the method comprises positioning a panel in the fenestration unit frame, the panel positioned below the first jamb, wherein an inner side of the first jamb faces a top edge of the panel. In one or more embodiments, at least a portion of the cavity is located between an outer side of the first jamb and the top edge of the panel, wherein the outer side of the first jamb faces away from the top edge of the panel.

In a third aspect, one or more embodiments of a fenestration unit as described herein include: a frame comprising a set of frame members connected to form the frame, wherein each frame member of the set of frame members comprises an inner side and an outer side, wherein the outer side of each frame member of the set of frame members is configured to face a building opening in which the frame is positioned when installed; a panel retained in the frame, the panel comprising a pair of major surfaces and a set of edges extending between the major surfaces about a perimeter of the panel, the set of edges comprising a selected edge facing a selected frame member of the set of frame members; a frame cavity located in the selected frame member, wherein the frame cavity is aligned with a frame member axis extending through the selected frame member from a first end to a second end of the selected frame member, and wherein the frame cavity is enclosed between the first and the second end of the selected frame member; and an intumescent member located in the frame cavity, the intumescent member aligned with the frame member axis and comprising intumescent material; wherein at least a portion of the frame cavity is defined by a sacrificial wall constructed of thermally sacrificial material such that the intumescent member expands outside of the frame cavity into a frame gap between the outer side of the selected frame member and the selected edge of the panel facing the inner side of the selected frame member. In one or more embodiments of a fenestration unit as described herein, the intumescent member comprises a strip of intumescent material extending from the first end to the second end of the selected frame member.

In one or more embodiments of a fenestration unit as described herein, the intumescent member is retained within the frame cavity when the fenestration unit is installed in a building opening.

In one or more embodiments of a fenestration unit as described herein, the intumescent member is retained within the frame cavity before the fenestration unit is installed in a building opening.

In one or more embodiments of a fenestration unit as described herein, the frame cavity is constructed of the thermally sacrificial material.

In one or more embodiments of a fenestration unit as described herein, the selected frame member is constructed of the thermally sacrificial material.

In one or more embodiments of a fenestration unit as described herein, the intumescent member occupies only a portion of a volume of the frame cavity.

In one or more embodiments of a fenestration unit as described herein, the intumescent member comprises a separate and discrete strip of intumescent material positioned in the frame cavity.

In one or more embodiments of a fenestration unit as described herein, at least a portion of the frame cavity is located between the outer side of the selected frame member and the selected edge of the panel.

In one or more embodiments of a fenestration unit as described herein, the frame cavity comprises a first frame cavity and the intumescent member comprises a first intumescent member, and wherein the selected frame member comprises a second frame cavity separate and distinct from the first frame cavity, the second frame cavity located between the inner side and the outer side of the selected frame member and aligned with the frame member axis, the fenestration unit comprising a second intumescent member located in the second frame cavity and aligned with the frame member axis. In one or more embodiments, the second frame cavity is located between the outer side of the selected frame member and the selected edge of the panel.

In one or more embodiments of a fenestration unit as described herein, the selected frame member comprises one of a head jamb, a side jamb, and a sill.

In a fourth aspect, one or more embodiments of a method of assembling a fenestration unit frame with concealed fire protection as described herein includes: positioning an intumescent member in a cavity of a selected frame member of the fenestration unit frame, wherein a first end of the intumescent member is proximate a first end of the selected frame member and a second end of the intumescent member is proximate a second end of the selected frame member, and wherein the cavity is enclosed within the selected frame member from the first end of the selected frame member to the second end of the selected frame member; attaching a second frame member to the first end of the selected frame member; and retaining the intumescent member in the cavity.

In one or more embodiments of a method of assembling fenestration unit frame with concealed fire protection as described herein, the intumescent member comprises a separate and discrete article from the selected frame member, and wherein positioning the intumescent member in the cavity comprises inserting the intumescent member into the cavity.

In one or more embodiments of a method of assembling fenestration unit frame with concealed fire protection as described herein, positioning the intumescent member in the cavity comprises inserting the first end of the intumescent member into the cavity at the second end of the selected frame member and advancing the first end of the intumescent member through the cavity towards the first end of the selected frame member.

In one or more embodiments of a method of assembling fenestration unit frame with concealed fire protection as described herein, the method comprises providing the intumescent member comprising the first end and the second end before positioning the intumescent member in the cavity.

In one or more embodiments of a method of assembling fenestration unit frame with concealed fire protection as described herein, retaining the intumescent member in the cavity comprises obstructing a first opening of the cavity at the first end of the selected frame member. In one or more embodiments, the method comprises attaching a second frame member of the fenestration unit frame to the selected frame member, and wherein obstructing the first opening comprises attaching the second frame member to the selected frame member proximate the first opening. In one or more embodiments, the method comprises attaching a second frame member of the fenestration unit frame to the selected frame member, and wherein obstructing the first opening comprises obstructing the first opening before attaching the second frame member to the selected frame member.

In one or more embodiments of a method of assembling fenestration unit frame with concealed fire protection as described herein, retaining the intumescent member in the cavity comprises inserting a mechanical fastener into the cavity.

Where used herein, the terms “exterior” and “interior” are used in a relative sense, for example, an exterior surface and an interior surface may be used to describe surfaces located on opposite sides of a fenestration unit. In actual use, and exterior surface could be found within the interior of a building or other structure where the surface would conventionally be defined as an interior surface, while an interior surface could be found outside of a building or other structure where the surface would conventionally be defined as an exterior surface.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

The above summary is not intended to describe each embodiment or every implementation of the fenestration unit frames with concealed intumescent features and fenestration units including such frames as well as related methods described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

Each of the figures described herein include axes corresponding to a three-dimensional Cartesian coordinate system to facilitate an understanding of the illustrative embodiments of the invention depicted in the figures and described herein.

FIG. 1 depicts one illustrative embodiment of a fenestration unit in the form of a hinged/rotating door system as described herein.

FIG. 2A is an enlarged view of the upper right-hand corner of the fenestration unit depicted in FIG. 1.

FIG. 2B is a view of FIG. 2A during placement of a pair of intumescent members in cavities in the jamb.

FIG. 3 is a view of FIG. 2A after obstructing the cavity openings on the end of the head jamb of the illustrative embodiment depicted in FIGS. 1 and 2A.

FIG. 4 is an enlarged cross-sectional view of the junction between a head jamb and a door panel in another illustrative embodiment of a fenestration unit as described herein, with the cross-sectional view being taken along line 4-4 at a location depicted in connection with the illustrative embodiment of a fenestration unit of FIG. 1.

FIG. 5 is an enlarged cross-sectional view of the junction between a side jamb and a door panel in another illustrative embodiment of a fenestration unit as described herein, with the cross-sectional view being taken along line 5-5 at a location depicted in connection with the illustrative embodiment of a fenestration unit of FIG. 1.

FIG. 6 is an enlarged cross-sectional view of the junction between a frame member and a panel in the form of a glazing panel in another illustrative embodiment of a fenestration unit as described herein, with the cross-sectional view being taken in a plane perpendicular to the major surfaces of the glazing panel.

FIG. 7 includes perspective views of a pair of intumescent members that can be used in fenestration unit frames and fenestration units as described herein.

FIG. 8 is a perspective view of one of the intumescent members of FIG. 7 during insertion into a cavity in a jamb of a fenestration unit frame as described herein.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

Although the illustrative embodiments depicted in the figures are focused on fenestration unit frames and fenestration units including the frames in the form of hinged doors, the fenestration unit frames and fenestration units described herein may be used in connection with any fenestration unit (e.g., window, door, etc.) including a frame having a side frame member and head jamb (where it is understood that the head jamb is the frame component typically installed at the top or uppermost portion of the fenestration unit). As such, the panels could be door panels, glazing panels/units, etc. and the fenestration unit frames could include door frames, window frames, sash frames, etc.

Although the depicted fenestration units include a hinged/rotating panel, the fenestration units and fenestration unit frames including concealed intumescent members as described herein may include panels that move in transition, i.e., slide or glide within the fenestration unit frame. As installed, the fenestration units and fenestration unit frames described herein have a frame that includes an exterior side and an interior side, where the exterior side typically (but not necessarily) faces the exterior of a building in which the fenestration units are installed and the interior side typically (but not necessarily) faces the interior of the building.

Further, although the illustrative embodiments described herein refer to frame members in the form of jambs for convenience, the frame members of the fenestration unit frames (and fenestration units including those frame) could be jambs (e.g., head, side, etc.), sills, mull posts, stiles, rails (e.g., check, bottom, side, etc.) unless otherwise specified herein.

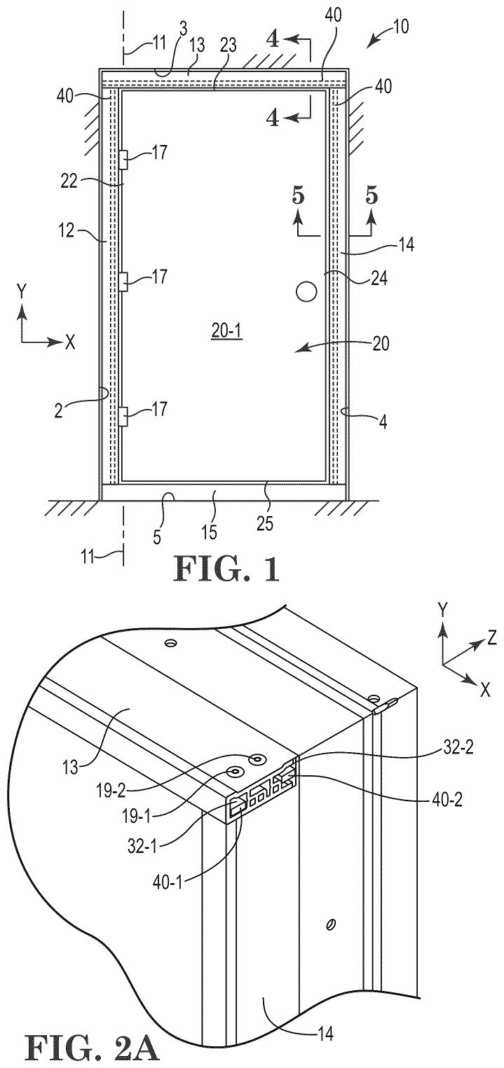

FIG. 1 depicts one illustrative embodiment of a fenestration unit including a fenestration unit frame as described herein in the form of a hinged door system. The depicted fenestration unit 10 includes a frame having a hinge side jamb 12, a head jamb 13, a latch side jamb 14, and an optional sill 15. Panel 20 (e.g., door panel 20) is located between hinge side jamb 12 and latch side jamb 14 and is connected to the hinge side jamb 12 by hinges 17. The door panel 20 is configured to rotate about a hinge axis 11 that is generally aligned with the hinge side jamb 12. The door panel 20 includes a hinge edge 22 facing the hinge side jamb 12 when the door panel 20 is in a closed configuration within the frame as depicted in FIG. 1. Door panel 20 also includes a latch edge 24 facing the latch side jamb 14, a top edge 23 facing the head jamb 13, and a bottom edge 25 facing the sill 15.

The fenestration unit 10 depicted in FIG. 1 is located within a building opening (also referred to herein as a rough opening) defined by a pair of side surfaces 2 and 4, an upper surface 3, and a bottom surface 5. When the fenestration unit 10 is installed in the building opening, exterior surface of the side jamb 12 faces side surface 2, exterior surface of side jamb 14 faces side surface 4, exterior surface of head jamb 13 faces upper surface 3, and the exterior surface of sill 15 faces on the bottom surface 5.

The jambs of the illustrative embodiments of fenestration units and fenestration unit frames described herein are described as head and side jambs for simplicity. The side jambs may take a variety of different forms depending on the fenestration units and fenestration unit frames described herein although the side jambs are typically oriented vertically (or nearly vertically) when the fenestration units and/or frames are installed in a building opening. The head jambs may also take a variety of different forms depending on the fenestration units and fenestration unit frames described herein although the head jambs are typically oriented horizontally (or nearly horizontally) when the fenestration units and/or frames are installed in a building opening. Fenestration units and fenestration unit frames including concealed intumescent members as described herein may be used include, but are not limited to, entry doors, patio doors, windows, etc. The side jambs in the fenestration units may be in the form of, e.g., jambs, astragals, meeting rails, check rails, mull posts (e.g., integral mull posts), interlocks (of gliding patio doors), etc.

One or more of the jambs (and/or portions of jambs) of one or more embodiments of fenestration units described herein, e.g., the side jambs 12/14 and head jamb 13 may be manufactured by a variety of processes. In one or more embodiments, however, one or more of the fenestration unit frame members (and/or portions of frame members) may be manufactured of an extruded/pultruded material. Fenestration unit frame members constructed in extrusion or pultrusion processes typically include hollows or cavities formed along their length. Examples of sacrificial materials that may be used to construct fenestration unit frame members as described herein include polymeric materials including one or more polymeric resins (along with suitable fillers/additives for strength, coloration, etc.) and/or composite materials including one or more polymeric resins (along with suitable fillers/additives for strength, coloration, etc.) along with one or more fibers. In one or more embodiments, the sacrificial material may be a composite material including one or more polymeric resins along with one or more fibers as described in U.S. Pat. No. 5,585,155 (Heikkila et al.); U.S. Pat. No. 6,106,944 (Heikkila et al.); U.S. Pat. No. 6,210,792 Seethamraju et al.); U.S. Pat. No. 6,260,251 (Guhl); U.S. Pat. No. 6,280,667 (Koenig et al.); and/or U.S. Pat. No. 6,342,172 (Finley). In one or more embodiments, the sacrificial material may be a composite material as described in U.S. Pat. Nos. 11,813,818, 11,680,439, and/or 10,550,257. Such materials constitute “sacrificial material” as defined herein when the material loses structural integrity through one or more of melting, disintegration, charring, and foaming when subjected to the UL 10C Fire Test as discussed herein.

In the fenestration units and fenestration unit frames described herein, at least one of the frame members, e.g., the head jamb, includes at least one intumescent member in a cavity extending along a length of at least a portion, preferably all, of the jamb located adjacent an edge of a panel located in the fenestration unit frame. In the depicted illustrative embodiment of fenestration unit 10, each of the side jambs 12 and 14 contain an intumescent member 40 concealed therein while head jamb 13 also contains an intumescent member 40 concealed therein. Although both side jambs 12 and 14 along with head jamb 13 include intumescent members 40 in the depicted illustrative embodiment, in one or more alternative embodiments, intumescent members may be concealed within any one or more of the head jamb 13, side jamb 12, and side jamb 14.

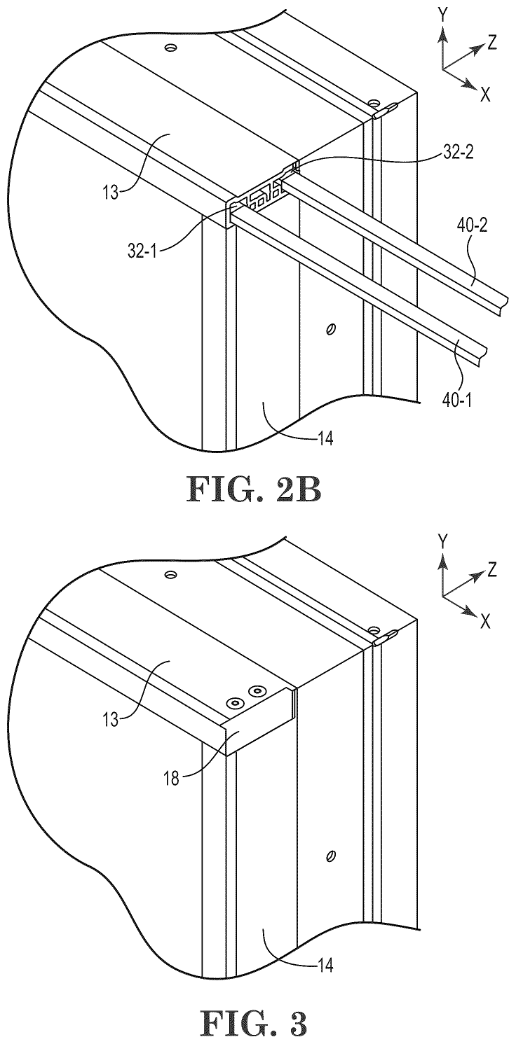

FIG. 2A is an enlarged perspective view of the upper right-hand corner of the depicted illustrative embodiment of the fenestration unit 10 depicted in FIG. 1 which includes the junction between the head jamb 13 and latch side jamb 14 at that corner. In the depicted illustrative embodiment, the head jamb 13 includes head cavities 32-1 and 32-2 visible at the exposed end of the head jamb 13 along with an intumescent feature in the form of intumescent member 40-1 located in head cavity 32-1 and intumescent member 40-2 in head cavity 32-2. FIG. 2B depicts the junction between the head jamb 13 and side jamb 14 during insertion of the intumescent members 40-1 and 40-2 into the cavities 32-1 and 32-2.

With reference to FIGS. 1 and 2A, one or more of the frame members (head jamb 13 and side jambs 12 and 14 in the depicted illustrative embodiment) includes at least one cavity containing at least one intumescent member therein. Each of any such cavities in frame members as described herein may include an opening into the cavity at each end of the frame member (for example, one of the openings into the cavities 32-1 and 32-2 is depicted in FIG. 2A).

Between the ends of the frame member and the cavity openings at each of those ends, the cavities are “enclosed” which, for the purposes of the present invention, means that the free passage of air and/or water into or out of the cavities is limited except for openings formed into or through the frame members for, e.g., fasteners needed to assemble the fenestration unit frame, fasteners needed to install the fenestration unit frame in a building/rough opening, hardware needed for operation and/or retention of a panel in the frame, locks, etc.

Also depicted in FIG. 2A are a pair of fasteners 19-1 and 19-2 that may be used to obstruct the cavities 32-1 and 32-2 to assist in retaining the intumescent members in the cavities as described herein. In one or more embodiments, the fasteners may also be used to attach the head jamb 13 to the side jamb 14 as part of the assembly process for the fenestration unit frame.

FIG. 3 is an enlarged side view of the same junction between head jamb 13 and side jamb 14 with the addition of a retainer 18 located over the exposed openings of the head cavities in the head jamb 13. The retainer 18 may be used to retain the intumescent member 40 in the head cavity 32-1 and/or to reduce exposure of the intumescent member 40 to conditions that could potentially degrade its intumescent properties (e.g., water, humidity, sunlight, etc.).

The intumescent members in cavities provide in frame members as described herein may be retained in the cavities using any suitable material/technique or combination of materials/techniques. In one or more embodiments, the openings at one or both openings at the ends of cavities in the frame members described herein may be obstructed to retain the intumescent members in the cavities. In other embodiments, a retainer may be provided over or in the cavity opening to retain an intumescent member therein. As depicted in FIG. 3, the retainer 18 may be in the form of a pressure sensitive adhesive tape as depicted in FIG. 3, but any suitable material/technique or combination of materials/techniques could be used in place of adhesive tape. As depicted in FIG. 2A, fasteners 19-1 and 19-2 (e.g., mechanical fasteners such as, e.g., threaded fasteners, pins, rivets, etc.) can be used to retain the intumescent members in the cavities. Examples of some additional potentially suitable alternatives could include, but are not limited to, films (secured using, e.g., staples or other fasteners), flowable sealant/adhesive introduced into the cavity openings after an intumescent member is located therein (e.g., expanding foam, caulk, flowable adhesive, etc.), corner keys, plugs configured to be retained in the end of the cavity, etc.

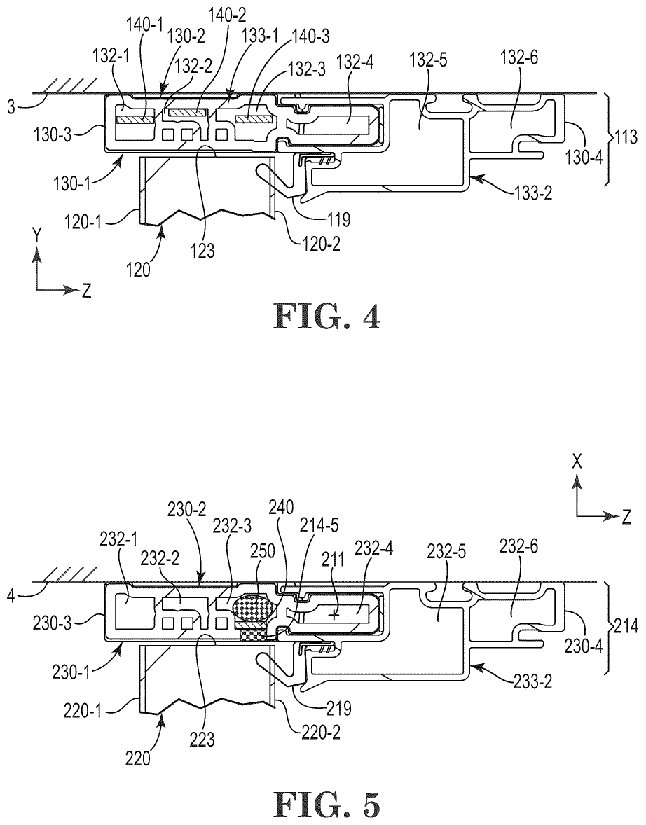

FIG. 4 is an enlarged cross-sectional view of the junction between a head jamb and a panel in another illustrative embodiment of a fenestration unit as described herein. The cross-sectional view may be taken along the junction between a top edge of a panel and a head jamb, one example of which would be a cross-sectional view taken along line 4-4 at a location depicted in connection with the illustrative embodiment of a fenestration unit of FIG. 1. It should be noted that while jamb 113 would be a head jamb and panel edge 123 would be a top edge of panel 120, the cross-sectional view depicted in FIG. 4 could alternatively be of a side edge of panel and a side jamb.

In the depicted illustrative embodiment, head jamb 113 includes an inner side 130-1 and an outer side 130-2. The outer side 130-2 of the head jamb 113 is configured to face a rough opening/building opening 3 in which a fenestration unit including head jamb 113 and panel 120 is positioned when installed. The depicted illustrative embodiment also includes panel 120 having a first surface 120-1 and a second surface 120-2, along with a top edge 123. As depicted in FIG. 4, the panel 120 is in a closed configuration relative to the head jamb 113 such that the edge 123 of panel 120 faces the inner side 130-1 of head jamb 113. An optional weatherstrip member 119 is also depicted in FIG. 4 with the surface 120-2 of panel 120 forming a seal with the weatherstrip member 119 when the panel 120 is in its closed configuration.

Head jamb 113 includes an interior edge 130-3 and an exterior edge 130-4 although, as noted elsewhere herein, the interior and exterior edges of the jamb 113 could be reversed, i.e., the interior edge 130-3 could face the exterior of a building opening while the exterior edge 130-4 could face the interior of a building opening. For the purposes of the present invention interior/exterior labels are used only for convenience in describing illustrative embodiments of the invention.

The depicted illustrative embodiment of head jamb 113 is actually a composite jamb in which an interior component 133-1 is attached with an exterior component 133-2, with a portion of the interior component 133-1 nested within a channel in the exterior component 133-2. Such composite jambs are known and will not be further described herein although it should be understood that the jambs of fenestration unit frames described herein may be a single unitary construction in place of the composite construction depicted in FIG. 4 and, in still other alternative embodiments, the jambs of fenestration units described herein may be composite jambs constructed of three or more components.

Although only one cavity is required in a jamb that could be used in connection with the fenestration unit frames and fenestration units incorporating such frames described herein, the depicted illustrative embodiment of head jamb 113 includes a series of six cavities 132-1, 132-2, 132-3, 132-4, 132-5, and 132-6 (collectively referred to as cavities 132 where appropriate).

Each of the cavities 132 may be described as being aligned with an axis 111 extending through the head jamb 113, with the axis 111 extending between side jambs located at each end of the head jamb 113 (noting that axis 11 would be aligned with the X axis of the Cartesian coordinate system depicted in FIG. 4).

Although not required, it may be preferred that one or more of the cavities 132 extend along the entire length of the jamb 113. For example, with reference to FIG. 1, a cavity may extend from one side jamb 12 to the opposite side jamb 14 such that the cavity is located above the edge 23 of panel 20 over its entire width.

Also depicted in FIG. 4 are intumescent members 140-1, 140-2, and 140-3 (collectively referred to as intumescent members 140 where appropriate), each of which is located in a cavity in head jamb 113, with intumescent member 140-1 being located in head cavity 132-1, intumescent member 140-2 being located in head cavity 132-2, and intumescent member 140-3 being located in head cavity 132-3. In one or more embodiments, each of the intumescent members 140 may be described as aligned with the axis 111 extending through the head jamb 113.

In one or more embodiments, the intumescent members 140 may be provided in the form of strips of intumescent material positioned in selected cavities 132. In the depicted embodiment and intumescent member 140 is provided in each of three different cavities 132. In other embodiments, one intumescent member 140 may be provided in one cavity 132 (as seen in, e.g., the illustrative embodiment depicted in FIG. 2). In still other embodiments, intumescent members 140 may be provided in two different cavities 132 while in still other embodiments, intumescent members 140 may be provided in any number of cavities in a jamb of a fenestration unit frame as described herein. Although only one intumescent member 140 is located in each of cavities 132-1, 132-2 and 132-3, it should be understood that one or more of the cavities 132 may include two or more intumescent members 140 in one or more alternative embodiments.

The strips of intumescent material used as intumescent members 140 may be described, in one or more embodiments, as separate and discrete strips of intumescent material positioned in each of the head cavities. In other words, the intumescent members are not formed with the jamb 113 through, for example, coextrusion or other techniques. Rather, the intumescent members 140 may be inserted into the cavities 132 after the jamb 113 is formed.

In one or more embodiments in which jamb 113 is a head jamb, one or more of the intumescent members 140 may extend between a first side jamb and a second side jamb of the fenestration unit frame incorporating the head jamb 113. For example, intumescent members located in head jamb 13 of the fenestration unit frame depicted in FIG. 1 would extend between the side jambs 12 and 14. In one or more embodiments, it may be preferred that one or more of the intumescent members extend over the entire length of the gap between the head jamb 13 and the top edge 23 of the panel 20 between the side jambs 12 and 14. Some gaps in the portion of a cavity 132 occupied by the intumescent members 140 could, of course, be tolerated if, overall, the expanded intumescent member 140 would occupy substantially the entire gap between the head jamb 113 and the top edge 123 of panel 120.

With reference to, e.g., FIGS. 2 and 4, in one or more embodiments, the intumescent members 40/140 may occupy only a portion of the volume of the cavities 32/132 in which they are located. The intumescent members may occupy only a portion of the cavity volumes to facilitate insertion of the intumescent members into their respective cavities in the jambs of fenestration unit frames as described herein.

For the intumescent members 140 in jamb 113 to expand to fill the gap between the inner surface 130-1 of the jamb 113 and the edge 123 of panel 120, the material used to form the jamb 113 may be manufactured of a thermally sacrificial material as described herein. As a result, the walls of the jamb 113 forming cavities 132 containing intumescent members 140 melt and/or disintegrate to expose the intumescent material in intumescent members 140 to heat and/or flames such that the intumescent material in intumescent members 140 expands to fill the gap between the edge 123 of panel 120 and the outer side 130-2 of the head jamb 113 with that gap being defined by the surface 3 of the rough opening against which the outer side 130-2 of head jamb 113 is positioned.

In one illustrative embodiment of jamb 113, the entire jamb 113 may be constructed of thermally sacrificial material as described herein, i.e., both the interior component 133-1 and the exterior component 133-2 of the composite jamb 113 may be constructed of thermally sacrificial material as described herein. In another embodiment, only the interior component 133-1 of the composite jamb 113 may be constructed of thermally sacrificial material as described herein. In still other embodiments, only the portions of the jamb 113 forming cavities 132 containing intumescent members 140 may be constructed of thermally sacrificial material as described herein.

In one or more embodiments of the fenestration unit frames and fenestration units incorporating those frames described herein, at least a portion of one cavity containing an intumescent member is located between the outer side of the jamb in which the cavity is located and the edge of a panel facing the inner side of the jamb.

With respect to the illustrative embodiment depicted in FIG. 1, it can be seen that at least a portion of the cavity 32 containing the intumescent member 40 is located between the outer side of the head jamb 13 and the top edge 23 of the panel 20.

With respect to the illustrative embodiment depicted in FIG. 4, at least a portion of the cavity 132-1 is located between the outer side 130-2 of jamb 113 and the edge 123 of panel 120 facing the inner side 130-1 of jamb 113. As a result, as the portion of the jamb 113 forming cavity 132-1 melts and/or disintegrates during a fire event, the intumescent material in intumescent member 140-1 can expand to fill the gap between the edge 123 of panel 120 and the surface 3 of the rough opening against which the outer side 130-2 of jamb 113 is positioned.

Also with reference to the illustrative embodiment depicted in FIG. 4, all of cavity 132-2 is located between the outer side 130-2 of jamb 113 and the edge 123 of panel 120 facing the inner side 130-1 of jamb 113. As a result, as the portion of the jamb 113 forming cavity 132-2 melts and/or disintegrates during a fire event, the intumescent material in intumescent member 140-2 can expand to fill the gap between the edge 123 of panel 120 and the rough opening against which the outer side 130-2 of jamb 113 is positioned.

Again with reference to the illustrative embodiment depicted in FIG. 4, essentially all of cavity 132-3 is located between the outer side 130-2 of jamb 113 and the edge 123 of panel 120 facing the inner side 130-1 of jamb 113. As a result, as the portion of the jamb 113 forming cavity 132-3 melts and/or disintegrates during a fire event, the intumescent material in intumescent member 140-3 can expand to fill the gap between the edge 123 of panel 120 and the surface 3 of the rough opening against which the outer side 130-2 of jamb 113 is positioned.

FIG. 5 is an enlarged cross-sectional view of the junction between a side jamb and a panel in another illustrative embodiment of a fenestration unit as described herein. The cross-sectional view of FIG. 5 may be taken along the junction between a side edge of a panel and a side jamb, one example of which would be a cross-sectional view taken along line 5-5 at a location depicted in connection with the illustrative embodiment of the fenestration unit of FIG. 1. It should be noted that while jamb 214 would be a side jamb and panel edge 224 of panel 220, the cross-sectional view depicted in FIG. 5 could alternatively be of the opposite side edge 222 of panel 220 and side jamb 212 or a top edge of a panel and a head jamb.

In the depicted illustrative embodiment, side jamb 214 includes an inner side 230-1 and an outer side 230-2. The outer side 230-2 of the side jamb 214 is configured to face a surface of a rough opening/building opening in which a fenestration unit including side jamb 214 is positioned when installed. The depicted illustrative embodiment also includes panel 220 having a first surface 220-1 and a second surface 220-2 along with a side edge 224. As depicted in FIG. 5, the panel 220 is in a closed configuration relative to the side jamb 214 such that the edge 224 of panel 220 faces the inner side 230-1 of side jamb 214. An optional weatherstrip member 219 is also depicted in FIG. 5 with the surface 220-2 of panel 220 forming a seal with the weatherstrip member 219 when the panel 220 is in its closed configuration.

Side jamb 214 also includes an interior edge 230-3 and an exterior edge 230-4 although, as noted elsewhere herein, the interior and exterior edges of the side jamb 214 could be reversed, i.e., the interior edge 230-3 could face the exterior of a rough opening/building opening while the exterior edge 230-4 could face the interior of a building opening. For purposes of the present invention, interior/exterior labels are used only for convenience describing illustrative embodiments of the invention.

The depicted illustrative embodiment of side jamb 214 is also a composite jamb in which an interior component 233-1 is attached to an exterior component 233-2, with a portion of the interior component 233-1 nested within a channel in the exterior component 233-2. Such composite jambs are known and will not be further described herein although it should be understood that the jambs of fenestration unit frames described herein may be a single unitary construction in place of the composite construction depicted in FIG. 5 and, in still other alternative embodiments, the jambs of fenestration units described herein may be composite jambs constructed of three or more components.

Although only one cavity is required in a jamb that could be used in connection with the fenestration unit frames and fenestration units incorporating such frames described herein, the depicted illustrative embodiment of a side jamb 214 includes a series of six cavities 232-1, 232-2, 232-3, 232-4, 232-5, and 232-6 (collectively referred to as cavities 232 where appropriate).

Each of the cavities 232 may be described as being aligned with an axis 211 extending through the side jamb 214, with the axis 211 extending along a length of the side jamb 214 from a head end to a sill end (noting that axis 211 would be aligned with the X axis of the Cartesian coordinate system depicted in FIG. 5). With reference to the illustrative embodiment of FIG. 1, the head end of side jamb 214 would be located proximate a head jamb of the fenestration unit frame incorporating the side jamb 214 (e.g., head jamb 13 and fenestration unit 10 of FIG. 1) and the sill end of side jamb 214 would be located proximate the sill (e.g., sill 15 in fenestration unit 10 of FIG. 1).

Although not required, it may be preferred that one or more of the cavities 232 and side jamb 214 extend along the entire length of the jamb 214. For example, with reference to FIG. 1, a cavity may extend from the head jamb 13 to the sill 15 such that the cavity is located along the side edge 24 of panel 20 along its entire length.

Also depicted in FIG. 5 is an intumescent member 240 located in cavity 232-3 of side jamb 214. In one or more embodiments, the intumescent member 240 may be described as aligned with axes 211 extending through the side jamb 214.

In one or more embodiments, the intumescent member 240 may be provided in the form of a strip of intumescent material positioned in cavity 232-3. Although only one intumescent member 240 in one cavity 232-3 is depicted in the illustrative embodiment of FIG. 5, it should be understood that more intumescent members could be provided in cavity 232-3 and/or that one or more intumescent members could be provided in other cavities of the side jamb 214.

The strip of intumescent material used as intumescent member 240 may be described, in one or more embodiments, as a separate and discrete strip of intumescent material positioned in the cavity 232-3. In other words, the intumescent member 240 is not formed with the jamb 214 through, for example, coextrusion or other techniques. Rather, the intumescent member 240 may be inserted into the cavity 232-3 after the jamb 214 is formed.

In one or more embodiments in which jamb 214 is a side jamb, intumescent member 240 may extend from the end of the jamb 214 proximate a head of a fenestration unit frame to the end of the jamb 214 proximate a sill of the fenestration unit frame. In one or more embodiments, it may be preferred that the intumescent member 240 extends over the entire length of the gap between the side jamb 214 and a side edge 224 of panel 220. Some gaps in the portion of the cavity 232-3 occupied by the intumescent member 240 could, of course, be tolerated if, overall, the expanded intumescent member 240 would occupy substantially the entire length of the gap between the side jamb 214 and a side edge 224 of panel 220.

The intumescent member 240 may occupy only a portion of the volume of the cavity 232-3 in which it is located. As discussed herein, intumescent members may occupy only a portion of the cavity volumes to facilitate insertion of the intumescent members into cavities in the jambs of fenestration units as described herein.

The illustrative embodiment depicted in FIG. 5 includes optional features that may be included in one or more embodiments of one or more jambs of fenestration unit frames as described herein. Among those optional features depicted in connection with the illustrative embodiment of FIG. 5 is a sacrificial section 214-5 of the jamb 214, with the sacrificial section 214-5 defining a portion of the cavity 232-3 in which the intumescent member 240 is located.

The sacrificial section 214-5 may be constructed of thermally sacrificial material that is particularly susceptible to melting and/or disintegration when exposed to heat and/or flames to expedite exposure of the intumescent material in intumescent member 240 during a fire event. In one or more embodiments, the remainder of the portion of jamb 214 forming cavity 232-3 may also fit within the definition of thermally sacrificial material as described herein but may not degrade as quickly as the thermally sacrificial material used to form the sacrificial section 214-5.

In one or more alternative embodiments, the remainder of the portion of the jamb 214 forming cavity 232-3 may not fit within the definition of thermally sacrificial material as described herein, in which case the thermally sacrificial material of sacrificial section 214-5 provides a pathway through which the intumescent material of intumescent member 240 can expand out of the cavity 232-3 and into the gap between the panel edge 224 and the jamb 214 (and, if needed, the surface 4 of the rough opening against which the jamb 214 is located).

Regardless of the construction of the remainder of the portion of the jamb 214 forming cavity 232-3, melting and/or disintegration of at least the sacrificial section 214-5 during a fire event exposes the intumescent material in the intumescent member 240 to heat and/or flames such that the intumescent material can expand to fill the gap between the edge 224 of panel 220 and the surface 4 of the rough opening against which the outer side 230-2 of the jamb 214 is positioned (in the case of a jamb 214 constructed of thermally sacrificial material) or the gap between the jamb 214 and the edge 224 of panel 220 if the remainder of the jamb 214 is constructive material that is not thermally sacrificial material as described herein.

Another optional feature included in the illustrative embodiment of jamb 214 is the addition of a director 250 positioned within the cavity 232-3 along with the intumescent member 240. In one or more embodiments the director 250 may be used to bias or urge the intumescent member 240 in a selected direction within the cavity 232-3. For example, the director 250 may bias or urge the intumescent member 240 towards the sacrificial section 214-5 of the cavity 232-3. Doing so may, for example, expedite activation of the intumescent material in the intumescent member 240. In one or more embodiments, the intumescent member 240 may be attached to the director 250 to, for example, facilitate insertion of both components into the cavity 232-3.

Although the depicted director 250 biases or urges the intumescent member 240 towards the sacrificial section 214-5, in one or more alternative embodiments, the director 250 may be used to bias or urge the intumescent member 240 in a different direction, e.g., away from the sacrificial section 214-5 of the cavity 232-3.

Further, although the director 250 is used in connection with an intumescent member 240 in a cavity 232-3 having a sacrificial section 214-5, in one or more alternative embodiments, directors may be used to bias or urge intumescent members in cavities of jambs as described herein that do not include a specific sacrificial section.

The directors used in connection with the fenestration unit frames and intumescent members described herein may take any number of a variety of different constructions including, but not limited to, metals, composites, foam strips, etc. it may be preferred that the directors used in connection with intumescent members in jambs as described herein be constructed of nonflammable materials including materials that would not satisfy the requirements for thermally sacrificial materials as discussed herein.

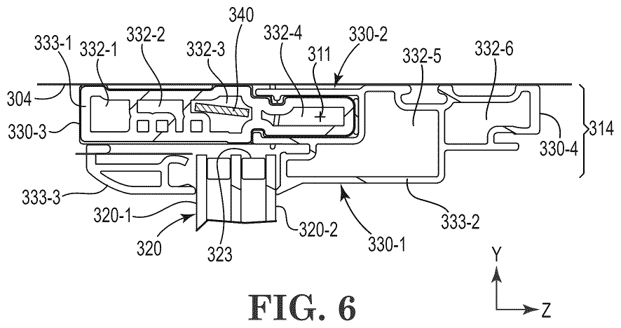

FIG. 6 is an enlarged cross-sectional view of the junction between a frame member and a panel in the form of glazing panel in another illustrative embodiment of a fenestration unit as described herein. The cross-sectional view of FIG. 6 may be taken along the junction between an edge of the glazing panel and a fenestration unit frame member in a plane oriented perpendicular to the major surfaces 320-1 and 320-2 of the glazing panel 320.

In the depicted illustrative embodiment, frame member 314 includes an inner side 330-1 and an outer side 330-2. The outer side 330-2 of the frame member 314 is configured to face a surface of a rough opening/building opening in which a fenestration unit including frame member 314 is positioned when installed. The glazing panel 320 has a first surface 320-1 and a second surface 320-2 along with an edge 323. As depicted in FIG. 6, the edge 323 of panel 320 faces the inner side 330-1 of frame member 314.

Frame member 314 also includes an interior edge 330-3 and an exterior edge 330-4 although, as noted elsewhere herein, the interior and exterior edges of the frame member 314 could be reversed, i.e., the interior edge 330-3 could face the exterior of a rough opening/building opening while the exterior edge 330-4 could face the interior of a building opening. For purposes of the present invention, interior/exterior labels are used only for convenience describing illustrative embodiments of the invention.

The depicted illustrative embodiment of frame member 314 is also a composite frame member in which an interior component 333-1 is attached to an exterior component 333-2, with a portion of the interior component 333-1 nested within a channel in the exterior component 333-2. Also included is a stop member 333-3 used to assist with retention of the glazing panel 320 in the fenestration unit. Such composite frame members are known and will not be further described herein although it should be understood that the frame members of fenestration unit frames described herein may be a single unitary construction in place of the composite construction depicted in FIG. 6.

Although only one cavity is required in a jamb that could be used in connection with the fenestration unit frames and fenestration units incorporating such frames described herein, the depicted illustrative embodiment of a frame member 314 includes a series of six cavities 332-1, 332-2, 332-3, 332-4, 332-5, and 332-6 (collectively referred to as cavities 332 where appropriate).

Each of the cavities 332 may be described as being aligned with an axis 311 extending through the frame member 314, with the axis 311 extending along a length of the frame member 314 aligned with the edge 323 of the glazing panel 320 (noting that axis 311 would be aligned with the X axis of the Cartesian coordinate system depicted in FIG. 6). Although not required, it may be preferred that one or more of the cavities 332 and frame member 314 extend along the entire length of the edge 323 of glazing panel 320.

Also depicted in FIG. 6 is an intumescent member 340 located in cavity 332-3 of frame member 314. In one or more embodiments, the intumescent member 340 may be described as aligned with axis 311 extending through the frame member 314.

In one or more embodiments, the intumescent member 340 may be provided in the form of a strip of intumescent material positioned in cavity 332-3. Although only one intumescent member 340 in one cavity 332-3 is depicted in the illustrative embodiment of FIG. 6, it should be understood that more intumescent members could be provided in cavity 332-3 and/or that one or more intumescent members could be provided in other cavities of the frame member 314.

The strip of intumescent material used as intumescent member 340 may be described, in one or more embodiments, as a separate and discrete strip of intumescent material positioned in the cavity 332-3. In other words, the intumescent member 340 is not formed with the frame member 314 through, for example, coextrusion or other techniques. Rather, the intumescent member 340 may be inserted into the cavity 332-3 after the frame member 314 formed.

In one or more embodiments, it may be preferred that the intumescent member 340 extends over the entire length of the gap between the frame member 314 and edge 323 of glazing panel 320. Some gaps in the portion of the cavity 332-3 occupied by the intumescent member 340 could, of course, be tolerated if, overall, the expanded intumescent member 340 would occupy substantially the entire length of the gap between the frame member 314 and edge 323 of glazing panel 320.

When viewed along the axis 311, the intumescent member 340 may occupy only a portion of the volume of the cavity 332-3 in which it is located. As discussed herein, intumescent members may occupy only a portion of the cavity volumes to facilitate insertion of the intumescent members into cavities in the jambs of fenestration units as described herein.

Melting and/or disintegration of the frame member 314 during a fire event exposes the intumescent material in the intumescent member 340 to heat and/or flames such that the intumescent material can expand to fill the gap between the edge 323 of glazing panel 320 and the surface 304 of the rough opening against which the outer side 330-2 of the frame member 314 is positioned.

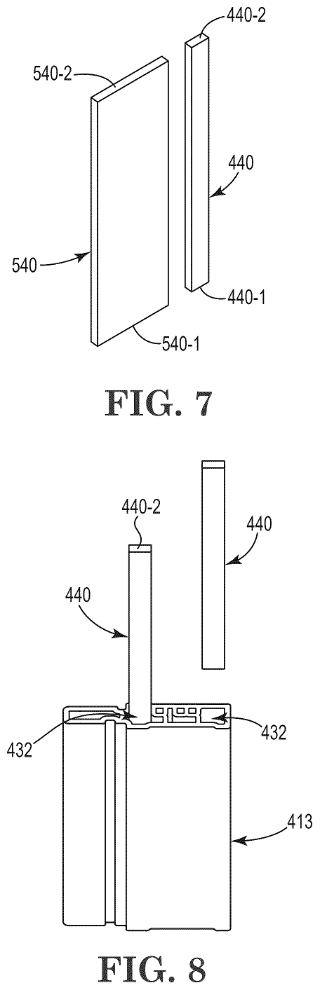

FIG. 7 depicts two illustrative embodiments of intumescent members that may be used in cavities of jambs of fenestration unit frames as described herein. Intumescent member 340 includes a first end 340-1 and a second end 340-2. Intumescent members 440 includes a first end 440-1 and a second end 440-2. The different intumescent members 340 and 440 illustrative that the intumescent members used in cavities of jambs of fenestration unit frames as described herein may take a variety of dimensions. Factors that may be considered in determining the proper dimensions of the intumescent members used in cavities of jambs of fenestration unit frames as described herein may include, but are not limited to, the size of the cavities into which the intumescent members are to be inserted, the size of the gap to be filled by the intumescent material upon expansion, etc.

A variety of intumescent materials may be used for intumescent members so long as the intumescent material can be provided as separate and discrete articles capable of insertion into a cavity in a jamb as described herein with those separate and discrete articles expanding when exposed to heat and/or flame during a fire event. In one or more embodiments, the intumescent members may be strips of an intumescent product marketed under the tradename 3M Fire Barrier Tuck-In Wrap Strips (3M Company). This product is marketed as having an expansion ratio up to 100× when exposed to heat and/or flame during a fire event. Other suitable products for use as intumescent members in the fenestration unit frames described herein could include, but are not limited to, 3M EXPANTROL Flexible Intumescent Strip E-FIS (3M Company), HS2000/HSS1000 Hot Smoke Seal (PEMKO ASSA ABLOY), NORSEAL FS1000 Foams and Tapes (Saint-Gobain Tape Solutions), PYROPLEX Intumescent Door Strips (Pyroplex Ltd), etc.

With reference to FIG. 8, one illustrative embodiment of a method of assembling a fenestration unit frame with concealed fire protection as described herein. The assembly process may occur during manufacturing of a fenestration unit frame (e.g., in the case of a pre-hung door, assembled window, etc.) or the assembly may occur in the field as part of a window or door installation. The illustrative method depicted in FIG. 8 includes positioning an intumescent member in a cavity of a frame member of a fenestration unit frame such that a first end of the intumescent member (e.g., end 340-1 of intumescent member 340) is already inserted into the opening of the cavity 332 on the left side of the frame member 313. The end of the frame member 313 depicted in FIG. 8 may be, for example, a first end of the frame member (e.g., the end of the head jamb 13 proximate the hinge side jamb 12 of fenestration unit 10 depicted in FIG. 1) and a second end of the intumescent member (e.g., end 340-2 of intumescent member 340) is proximate a second end of the head jamb (e.g., the end of the head jamb 13 proximate the latch side jamb 14 of fenestration unit 10 depicted in FIG. 1). The method further includes attaching a first side jamb to the first end of the head jamb (e.g., attaching the hinge side jamb 12 to the hinge end of the head jamb 13 of fenestration unit 10 depicted in FIG. 1) and attaching a second side jamb to the second end of the head jamb (e.g., attaching the latch side jamb 14 to the latch side end of the head jamb 13 of fenestration unit 10 depicted in FIG. 1). The method also includes retaining the intumescent member in the head cavity in the head jamb.

As described herein, in one or more embodiments, the intumescent member is in the form of an article that is separate and discrete from the head jamb and positioning the intumescent member in the head cavity comprises inserting the intumescent member into the head cavity as depicted in, e.g., FIG. 8 where intumescent member 340 is being inserted into the left-side cavity 332 in frame member 313. More particularly, as depicted in FIG. 8 the method may involve inserting the first end 340-1 of the intumescent member 340 into the cavity 332 and advancing the first end of the intumescent member through the head cavity towards the opposite end of the frame member 313. A second intumescent member 340 is also depicted in FIG. 8 before insertion into the right-side cavity 332 in frame member 313.

In one or more embodiments, the length of the intumescent member may be defined before beginning the insertion process into the cavity while in other embodiments the intumescent member may be provided in a continuous form with an end of the intumescent member being advanced through the cavity followed by severing the continuous strip of intumescent material when the intumescent member reaches a selected location within the cavity. In one or more embodiments in which the frame member containing an intumescent member in a cavity as described herein is, for example, an article having an extended length from which individual frame members are obtained by cutting the article to a selected length, the intumescent material may be located in a cavity in the article before the article is cut to form the frame member such that the intumescent member has the same length as the cavity.

As also described herein, the methods may involve obstructing at least one opening of a cavity containing an intumescent member at one end of a frame member after positioning the intumescent member in the cavity. In one or more embodiments, the methods may involve sealing both openings of a cavity in a frame member at opposite ends of the frame member after positioning the intumescent member in the cavity. In one or more embodiments, the obstructing may include attaching adhesive tape over the opening of the cavity at the end of the frame member, but any suitable material/technique or combination of materials/techniques could be used in place of adhesive tape as described herein.

The complete disclosure of any patents, patent documents, and publications identified herein are incorporated by reference in their entirety as if each were individually incorporated. To the extent there is a conflict or discrepancy between this document and the disclosure in any such incorporated document, this document will control.

Illustrative embodiments of fenestration unit frames and fenestration units including concealed intumescent members and related methods are discussed herein with some possible variations described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

1. A fenestration unit comprising:
a frame comprising a set of frame members connected to form the frame, wherein each frame member of the set of frame members comprises an inner side and an outer side, wherein the outer side of each frame member of the set of frame members is configured to face a building opening in which the frame is positioned when installed;
a panel retained in the frame, the panel comprising a pair of major surfaces and a set of edges extending between the major surfaces about a perimeter of the panel, the set of edges comprising a selected edge facing a selected frame member of the set of frame members;
a frame cavity located in the selected frame member, wherein the frame cavity is aligned with a frame member axis extending through the selected frame member from a first end to a second end of the selected frame member, and wherein the frame cavity is enclosed between the first and the second end of the selected frame member; and
an intumescent member located in the frame cavity, the intumescent member aligned with the frame member axis and comprising intumescent material;
wherein at least a portion of the frame cavity is defined by a sacrificial wall constructed of thermally sacrificial material such that the intumescent member expands outside of the frame cavity into a frame gap between the outer side of the selected frame member and the selected edge of the panel facing the inner side of the selected frame member.

2. A fenestration unit according to claim 1, wherein the intumescent member comprises a strip of intumescent material extending from the first end to the second end of the selected frame member.

3. A fenestration unit according to claim 1, wherein the intumescent member is retained within the frame cavity when the fenestration unit is installed in a building opening.

4. A fenestration unit according to claim 1, wherein the intumescent member is retained within the frame cavity before the fenestration unit is installed in a building opening.

5. A fenestration unit according to claim 1, wherein the frame cavity is constructed of the thermally sacrificial material.

6. A fenestration unit according to claim 1, wherein the selected frame member is constructed of the thermally sacrificial material.

7. A fenestration unit according to claim 1, wherein the intumescent member occupies only a portion of a volume of the frame cavity.

8. A fenestration unit according to claim 1, wherein the intumescent member comprises a separate and discrete strip of intumescent material positioned in the frame cavity.

9. A fenestration unit according to claim 1, wherein at least a portion of the frame cavity is located between the outer side of the selected frame member and the selected edge of the panel.

10. A fenestration unit according to claim 1, wherein the frame cavity comprises a first frame cavity and the intumescent member comprises a first intumescent member, and wherein the selected frame member comprises a second frame cavity separate and distinct from the first frame cavity, the second frame cavity located between the inner side and the outer side of the selected frame member and aligned with the frame member axis, the fenestration unit comprising a second intumescent member located in the second frame cavity and aligned with the frame member axis.

11. A fenestration unit according to claim 10, wherein the second frame cavity is located between the outer side of the selected frame member and the selected edge of the panel.

12. A fenestration unit according to claim 1, wherein the selected frame member comprises one of a head jamb, a side jamb, and a sill.

13. A method of assembling a fenestration unit frame with concealed fire protection, the method comprising:
positioning an intumescent member in a cavity of a selected frame member of the fenestration unit frame, wherein a first end of the intumescent member is proximate a first end of the selected frame member and a second end of the intumescent member is proximate a second end of the selected frame member, and wherein the cavity is enclosed within the selected frame member from the first end of the selected frame member to the second end of the selected frame member;
attaching a second frame member to the first end of the selected frame member; and
retaining the intumescent member in the cavity.

14. A method according to claim 13, wherein the intumescent member comprises a separate and discrete article from the selected frame member, and wherein positioning the intumescent member in the cavity comprises inserting the intumescent member into the cavity.

15. A method according to claim 13, wherein positioning the intumescent member in the cavity comprises inserting the first end of the intumescent member into the cavity at the second end of the selected frame member and advancing the first end of the intumescent member through the cavity towards the first end of the selected frame member.

16. A method according to claim 13, wherein the method comprises providing the intumescent member comprising the first end and the second end before positioning the intumescent member in the cavity.

17. A method according to claim 13, wherein retaining the intumescent member in the cavity comprises obstructing a first opening of the cavity at the first end of the selected frame member.

18. A method according to claim 17, wherein the method comprises attaching a second frame member of the fenestration unit frame to the selected frame member, and wherein obstructing the first opening comprises attaching the second frame member to the selected frame member proximate the first opening.

19. A method according to claim 17, wherein the method comprises attaching a second frame member of the fenestration unit frame to the selected frame member, and wherein obstructing the first opening comprises obstructing the first opening before attaching the second frame member to the selected frame member.

20. A method according to claim 13, wherein retaining the intumescent member in the cavity comprises inserting a mechanical fastener into the cavity.

21. A method according to claim 13, wherein the method comprises positioning a panel in the fenestration unit frame, wherein an inner side of the selected frame member faces an edge of the panel, and wherein at least a portion of the cavity is located between an outer side of the selected frame member and the edge of the panel, wherein the outer side of the selected frame member faces away from the edge of the panel.
